(19) United States
(12) Patent Application Publication
(10) Pub. No.: US 2026/0121448 A1
(43) Pub. Date: Apr. 30, 2026

(54) NETWORK-WIDE POWER HARVESTING ORCHESTRATION

(71) Applicant: Cisco Technology, Inc., San Jose, CA (US)

(72) Inventors: Snezana Mitrovic, Leefdaal (BE); Vinay Saini, Bangalore (IN); Timothy Peter Stammers, Raleigh, NC (US); Alwin Xavier Pulikkal Xavier, Tienen (BE); Marisol Palmero, Toledo (ES)

(21) Appl. No.: 18/931,850

(22) Filed: Oct. 30, 2024

(51) Int. Cl. H02J 50/00; G06Q 10/0631; H02J 3/00; H02J 50/20

(52) U.S. Cl. CPC H02J 50/001; G06Q 10/06313; H02J 3/004; H02J 50/20; H02J 2103/30

(57) ABSTRACT

Methods are provided which involve obtaining energy related parameters of Internet of Things (IoT) devices including an indication of whether a power sourcing mode and/or a power consuming mode are enabled on the IoT devices. The methods further involve detecting network devices of at least two communication networks configured to charge the IoT devices and to harvest energy and generating a power harvesting schedule for harvesting the energy and/or for charging the IoT devices based on the plurality of network devices and the energy related parameters. The power harvesting schedule includes a selected network device of the plurality of network devices and at least one time window. The methods further involve providing an instruction to the selected network device to charge the IoT devices and/or to harvest the energy, based on the power harvesting schedule.

### TECHNICAL FIELD

The present disclosure generally relates to power management.

### BACKGROUND

The number of Internet of Things (IoT) devices is growing rapidly. IoT devices include, among other things, sensors, tags, and wearables, which may be powered by radio waves, solar energy, heat, vibrations, and other energy sources in their environment. Some of these IoT devices may be deployed in locations where it is not easy to charge their batteries, e.g., surveillance sensors, infrastructure management systems, etc. Moreover, some of these IoT devices e.g., ambient IoT devices, may not even have a battery and rely solely on other energy sources. Remote wireless charging allows these devices to operate. For example, an IoT device may collect energy from radio frequency signals in cellular network(s). Without adequate energy, these devices cannot perform their intended function(s) such as sensing, monitoring, controlling, and/or reporting functions. The proliferation of IoT devices that rely on energy harvesting presents a challenge for networks and can impact Scope 2 and Scope 3 greenhouse gas emissions.

### BRIEF DESCRIPTION OF THE DRAWINGS

FIG. 1 is a diagram illustrating an environment in which wireless charging of IoT devices and energy harvesting from IoT devices are performed according to a power harvesting schedule generated by a power harvesting orchestrator, according to an example embodiment.

FIG. 2 is a sequence diagram illustrating a method of performing wireless charging of IoT devices and harvesting energy from IoT devices based on the generated power harvesting schedule, according to an example embodiment.

FIG. 3 is a diagram illustrating an environment in which multiple network devices of different communication networks charge a set of IoT devices, according to an example embodiment.

FIG. 4 is a sequence diagram illustrating a method of performing wireless charging of IoT devices based on predictive energy harvesting patterns of the IoT devices, according to an example embodiment.

FIG. 5 is a flowchart illustrating a computer-implemented method of generating a power harvesting schedule and providing instructions for charging one or more IoT devices and/or harvesting energy from the one or more IoT devices based on the power harvesting schedule, according to an example embodiment.

FIG. 6 is a hardware block diagram of a computing device that may perform functions associated with any combination of operations in connection with the techniques depicted and described in FIGS. 1-5, according to various example embodiments.

### DETAILED DESCRIPTION

### Overview

Techniques presented herein provide for wireless charging of IoT devices and for harvesting energy from network devices and/or IoT devices across multiple network domains.

In one form, a method is provided that involves obtaining energy related parameters of one or more Internet of Things (IoT) devices. The energy related parameters include an indication of whether a power sourcing mode and/or a power consuming mode are enabled on the one or more IoT devices. The method further involves detecting a plurality of network devices of at least two communication networks that are configured to charge the one or more IoT devices and to harvest energy. The method further involves generating a power harvesting schedule for harvesting the energy and/or for charging the one or more IoT devices based on the plurality of network devices and the energy related parameters. The power harvesting schedule includes a selected network device of the plurality of network devices and at least one time window. The method also involves providing an instruction to the selected network device to charge the one or more IoT devices and/or to harvest the energy, based on the power harvesting schedule.

### Example Embodiments

As noted above, with the proliferation of battery-operated wireless devices, particularly in Internet of Things (IoT) environments, the capability to remotely charge and recharge these devices over a wireless technology is beneficial. Existing communication networks such as cellular networks, wireless access networks, enterprise networks, etc., may charge these devices using radio frequency (RF) waves such as millimeter waves (mmWaves). Cellular networks may include fourth generation (4G) long-term evolution (LTE) network and emerging fifth generation (5G) or sixth generation (6G) cellular networks. Wireless access networks may include wireless local access network (e.g., Wi-Fi® wireless local area networks). Enterprise networks involve various private networks such as a 5G private network. A network device may also use Power over Ethernet (PoE) and/or fault managed power (FMP) to wirelessly charge IoT devices e.g., delivering the power in mmWaves to the IoT devices.

When massive numbers of IoT devices are connected to various communication networks, managing wireless charging of these devices can be complicated. Further, some IoT devices may include power sourcing capabilities. That is, some IoT devices may operate in a power sourcing mode and a power consuming mode. For example, these IoT devices may be charged with ambient power i.e., energy derived from a renewable energy source such as solar power and/or wind power. For this purpose, an IoT device may include a small solar panel for harvesting solar energy. Coordinating between harvesting energy from these devices and charging these devices is a complex task. There is a lack of mechanisms available to dynamically manage energy harvesting and charging of IoT devices. Moreover, as ways of charging IoT devices expand, it can be even more challenging to coordinate cross network domain charging and energy harvesting. There are no technologies heretofore known that have mechanisms for efficient and dynamic management of energy harvesting from the IoT devices and charging of the IoT devices using multiple networks i.e., performing cross domain power management.

Additionally, power being drowned by network(s) and individual devices impacts Scope 2 and Scope 3 greenhouse gas emissions. Sustainability may be a factor for many enterprises, and consequently, energy should be harvested when it is possible, instead of wasting this energy in the air. While research and development focus on harvesting energy via Wi-Fi wireless networks, energy harvesting is not efficient. There is a lack of coordination between energy harvesting from devices via a network. A dynamic wireless charging coordination and management system and method, tailored to the scale and constraints of IoT devices, are desirable.

The techniques presented herein coordinate energy harvesting from IoT devices and charging of IoT devices across various network domains i.e., communication networks. The techniques presented herein obtain energy related parameters of IoT devices including an indication of whether a power sourcing mode and/or a power consuming mode are enabled on these devices and further detect network devices of various communication networks (multiple domains) that are configured to charge one or more IoT devices and to harvest energy from the one or more IoT devices. The techniques presented herein generate a power harvesting schedule for harvesting the energy from these IoT devices and/or charging these IoT devices based on the detected network devices and the energy related parameters. The power harvesting schedule includes selected network device(s) and various time windows for charging a set or group of devices and harvesting energy from these IoT devices. The techniques presented herein further involve providing instructions to the selected network device(s) to charge these IoT devices and/or to harvest the energy from these IoT devices, based on the power harvesting schedule.

The techniques presented herein involve a new enterprise network-wide power harvesting orchestrator (PHO) that efficiently manages charging of IoT devices across multiple network domains, leveraging energy from various energy sources such as mmWave, Wi-Fi wireless network, and 5G/6G cellular networks. The PHO orchestrates and coordinates energy harvesting and generates a power harvesting schedule that prioritizes the energy from the one or more IoT devices and such that charging of the one or more IoT devices is performed so as to reduce interference with harvesting the energy.

While one or more example embodiments are described with reference to cellular communication networks and wireless access networks, the disclosure is not limited thereto. Example embodiments apply to other communication networks now known or later developed. Moreover, while example embodiments are described with reference to IoT devices, the disclosure is not limited thereto. Example embodiments apply to other devices that may harvest energy and and/or be charged using various communication networks.

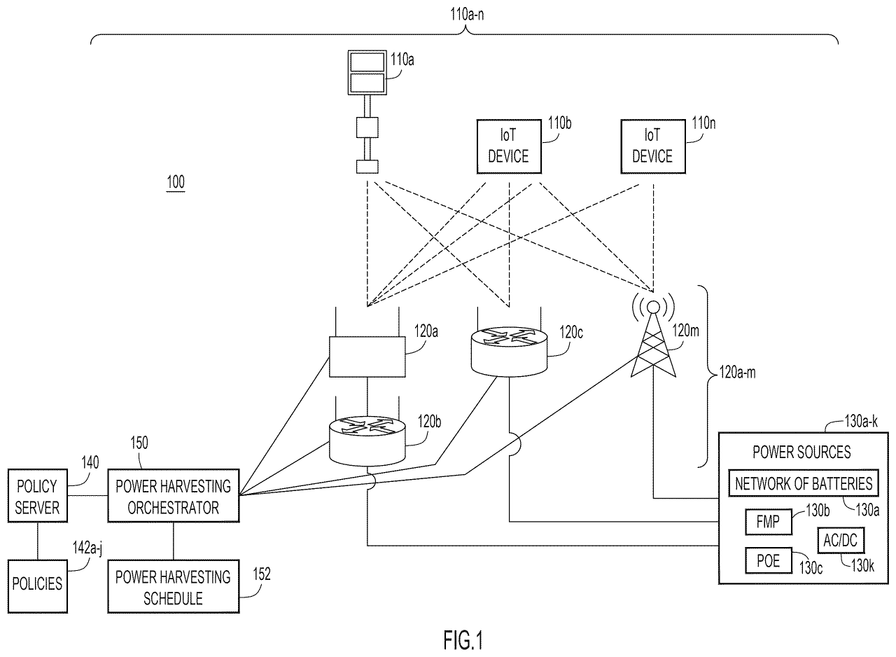

FIG. 1 is a block diagram illustrating an environment 100 in which wireless charging of IoT devices and energy harvesting from IoT devices are performed according to a power harvesting schedule generated by a power harvesting orchestrator, according to an example embodiment. The environment 100 includes IoT devices 110a-n such as a first IoT device 110a, a second IoT device 110b, and a third IoT device 110n. The environment 100 further includes network devices 120a-m such as an access point 120a, a router 120b, an integrated service router (ISR) 120c, and a base station 120m. The environment 100 also includes power sources 130a-k including a network of batteries 130a, a fault managed power (FMP) power source 130b, a Power-over-Ethernet (PoE) power source 130c, and traditional power sources (e.g., alternating current (AC)/direct current (DC)) power source 130k. Additionally, the environment 100 includes a policy server 140 and a power harvesting orchestrator 150.

The notations 1, 2, 3, . . . n; a, b, c, . . . n; “a-n”, “a-m”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

As noted above, an IoT device may be any device that collects and exchanges data over network(s). IoT devices may transmit data over one or more networks and perform a specific function such as monitoring, sensing, reporting, and/or processing. IoT devices are widely used in industries such as consumer electronics, smart cities, healthcare, automotive, etc. For example, an IoT device may be a streetlight or a remotely installed sensor that is difficult to reach by a user i.e., stationary IoT devices. As another example, an IoT device may be a dash camera in a moving vehicle or a monitor in a medical device i.e., mobile IoT devices.

An IoT device may be a device in an IoT environment that harvests energy from viable energy source(s) e.g., air power charging. IoT devices 110a-n may be compact in size (small form factor), low in complexity, and low in power consumption. Some IoT technologies involve IoT devices 110a-n with no energy storage capability e.g., wireless sensors, or devices with energy storage that is not replaceable or manually rechargeable. For example, an IoT device may operate without a dedicate power source (e.g., a battery) and may harvest energy from an electromagnetic source. Some IoT devices may have capacity for energy storage but are still low in complexity and power consumption.

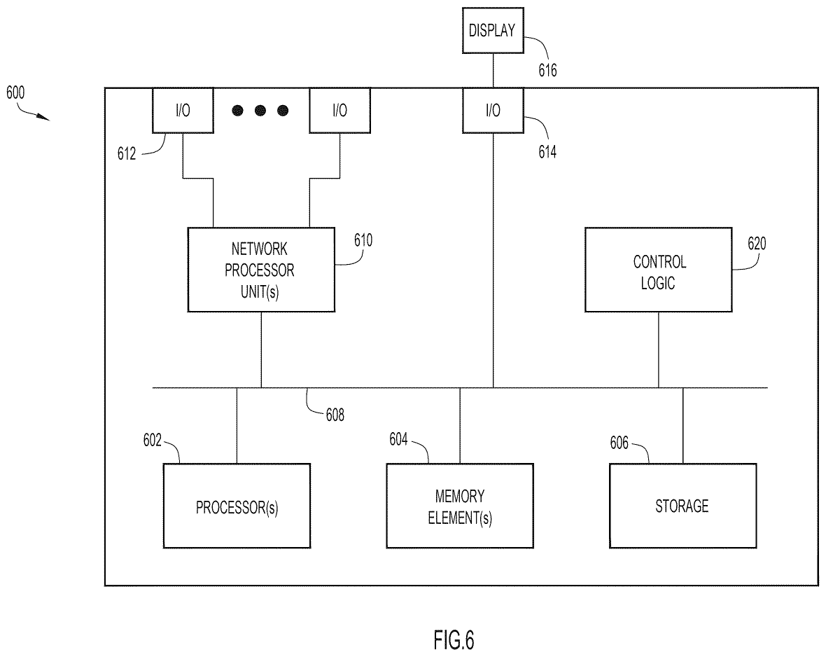

Each of the IoT devices 110a-n may include a processor, a sensor, and/or a memory in addition to a network interface. Some of the IoT devices that have a power sourcing mode include a harvesting system e.g., solar panels. An IoT device may be an apparatus or any programmable electronic or computing device capable of executing computer readable program instructions. The IoT devices 110a-n may include internal and external hardware components such as those depicted and described in FIG. 6.

The network interface may include one or more network interface cards (having one or more ports) that enable components of the IoT device to send and receive packets or data over network(s) such as a local area network (LAN), a wide area network (WAN), and/or wireless access networks. The network interface may connect the IoT device to a radio access network (RAN) for data communication over a core network e.g., cellular network such as 5G core network, 4G LTE, etc. The network interface may connect the IoT device to an enterprise network via a network device (e.g., integrated service router (ISR)). The network interface may further connect the IoT device to a local access network via another network device (e.g., an access point of a Wi-Fi network).

The harvesting system includes a radio frequency (RF) energy receiving antenna and a rectifier that converts RF signals into energy for use by a respective IoT device. The IoT devices 110a-n are configured to periodically monitor respective energy levels. When an energy level depletes below a predetermined threshold value for an IoT device, the IoT device may generate a charging assistance request message with a device identifier, a current energy level, location coordinates (e.g., Global Positioning System (GPS) coordinates), etc.

In the environment 100, the IoT devices 110a-n include a first IoT device 110a, a second IoT device 110b, and a third IoT device 110n. The first IoT device 110a may be configured to harvest energy e.g., using solar panels as a power source. This is provided by way of an example only of an IoT device having a power sourcing mode enabled, and the disclosure is not limited thereto. An IoT device may harvest energy from other sources e.g., wind or water. That is, the solar panel is just one example of a power source, power may come from any other source such as kinetic, thermal, etc.

The first IoT device 110a may provide excess energy via one of the network devices 120a-m to another IoT device. The second IoT device 110b may be enabled only for a power consuming mode. That is, it lacks power sourcing capabilities. The third IoT device 110n may be enabled in both modes i.e., a power consuming mode and a power sourcing mode. The third IoT device 110n may harvest mmWave power or energy.

The IoT devices 110a-n may be power charged or recharged via the network devices 120a-m. The network devices 120a-m are network devices configured to connect the IoT devices 110a-n to respective communication networks for communication and to transmit power to and from the IoT devices 110a-n. A network device may be an apparatus or any programmable electronic or computing device capable of executing computer readable program instructions. The network device may include internal and external hardware components such as those depicted and described in FIG. 6.

That is, in addition to facilitating communication for the IoT devices 110a-n, at least some of the network devices 120a-m are energy beamforming charging resources configured to charge the IoT devices 110a-n and configured to harvest energy from the IoT devices 110a-n. For example, these network devices 120a-m may generate and transmit RF energy signals (energy beams) towards IoT devices 110a-n for charging e.g., in the form of millimeter wave (mmWave) charging frames. The network devices 120a-nm may provide continuous energy or power charging while also streaming data. The network devices 120a-m communicate with and charge the IoT devices 110a-n by transmitting RF signals via a near air interface e.g., NR-Uu interface. For example, a selected network device may be set in an energy harvesting mode such that the selected network device receives energy from the first IoT device 110a via a first port and also set in a charging mode such that the selected network device charges the second IoT device 110b by transmitting power to the second IoT device 110b via a second port.

While in the environment 100, the network devices 120a-m are configured to communicate with the IoT devices 110a-n using transmissions such as mmWave transmissions, the disclosure is not limited thereto. The network devices 120a-m may be a gateway device, a switch, a router, a modem, an access point, a base station, a radio node, etc. Additionally, the network devices 120a-m may include a network controller that controls other network devices in its network based on instructions from the power harvesting orchestrator 150. In the environment 100, the network devices 120a-m include the access point 120a, the router 120b, the ISR 120c, and the base station 120m. In one or more example embodiments, the network devices 120a-m may be power sourcing devices that are configured to harvest energy from a renewable energy source e.g., sun, wind, water, air. As an example, a router may include a solar panel to harvest solar energy, which may then be sent back to the network via a bidirectional PoE and/or used to charge IoT device(s).

The IoT devices 110a-n attach to the access point 120a via a wireless local access network e.g., Wi-Fi network, and may communicate with the power harvesting orchestrator 150. In one example embodiment, the access point 120a may be connected to the router 120b, which further connects the access point 120a to the power sources 130a-k. The power may be transmitted bi-directionally between the access point 120a and the router 120b. The power may include PoE and/or FMP obtained by the router 120b from the power sources 130a-k. The access point 120a may convert between PoE or FMP and radio frequency or mmWaves, to facilitate transmission of power in the environment 100. The router 120b is an example of an intermediate network device that distributes power between power sources 130a-k and/or other network devices. In one example embodiment, the router 120b may include a solar panel to harvest solar energy.

The ISR 120c also connects the IoT devices 110a-n to a communication network (e.g., a private 5G network) and may obtain power from the power sources 130a-k and transmit it to the IoT devices 110a-n. Additionally, the ISR 120c may be configured to harvest energy from the IoT devices 110a-n and supply power to other devices (including the power sources 130a-k) in the environment 100 (i.e., bi-directional power).

The base station 120m connects the IoT devices 110a-n to a cellular network. For example, the base station 120m may be an open radio access network (O-RAN) node (O-RU node). The O-RU node is a logical node that hosts low-physical (PHY) layer and RF processing. In addition to facilitating communication for the IoT devices 110a-n, the base station 120m is an energy beamforming charging resource configured to charge the IoT devices 110a-n and configured to harvest energy from the IoT devices 110a-n. When the base station 120m is a 5G gNodeB of an open radio access network, it generates and transmits RF energy signals (energy beams) towards an IoT device for charging e.g., in the form of millimeter wave (mmWave) charging frames.

In one example embodiment, the access point 120a, the ISR 120c, and the base station 120m may simultaneously charge the IoT devices 110a-n based on instructions from the power harvesting orchestrator 150. In other words, multiple network devices (e.g., a first network device of a first communication network and a second network device of a second communication network different than the first communication network) may be selected and configured to set their beam directions to transmit power for charging a set of IoT devices (in a predetermined location) during the same time window.

The power sources 130a-k include the network of batteries 130a, the FMP power source 130b, the PoE power source 130c, and the AC/DC power source 130k. These are just some examples of the power sources 130a-k and other power sources are within the scope of this disclosure. An enterprise and/or users may set rules for when to use which power source as part of a policy. The policy may be stored on the policy server 140.

Specifically, the policy server 140 is configured to store one or more rules related to charging the IoT devices 110a-n and to selecting network devices 120a-m. The rules (i.e., a policy) may be set by an enterprise and/or users. The policy may include a charging duration, an energy harvesting duration, a charging time, an energy harvesting time, and parameters for selecting one or more network devices among the network devices 120a-m for charging and/or harvesting the energy.

In one or more example embodiments, the policy may define a particular power source e.g., prioritize power using the FMP power source 130b. The policy may further specify criteria for selecting network device(s). For example, the rule may indicate to select a network device based on proximity (location), load level (busy network), availability of resources in a particular network (beam forming parameters, antenna attributes, etc.), and/or availability of harvesting energy. The policy may prioritize harvesting energy from the IoT devices 110a-n and/or network devices 120a-m when possible (availability of a renewable energy source) and set rules that charging of the IoT devices 110a-n is performed to reduce interference with harvesting the energy. The policy server 140 stores policies 142a-j that are set and/or updated by enterprise(s) and/or user(s). The policy server 140 provides one or more of the policies 142a-j in response to a request from the power harvesting orchestrator 150.

The power harvesting orchestrator 150 is configured to orchestrate an energy harvesting process for the IoT devices 110a-n. With the number of IoT devices 110a-n growing exponentially, it may be cumbersome and time consuming to orchestrate the energy harvesting process through these multiple networks (across domains) without the power harvesting orchestrator 150. In addition, power sourcing mode in some of these IoT devices 110a-n further complicate the power distribution process.

The power harvesting orchestrator 150 generates a power harvesting schedule 152 for harvesting energy from the one or more IoT devices and/or for charging the one or more IoT devices based on availability and attributes of the network devices 120a-m and energy related parameters of the IoT devices 110a-n. The power harvesting schedule 152 may include a selected network device and at least one time window.

In one example embodiment, the power harvesting orchestrator 150 may obtain inventory of devices in a respective communication network from a network controller. The inventory may include identifications and locations of rechargeable IoT devices connected to the respective network e.g., a Wi-Fi network or a private 5G network. The inventory may further include energy related parameters for these connected devices such as an indication of whether a power sourcing mode and/or a power consuming mode are enabled, charging capacity, antenna type, etc. In one example embodiment, the location of the rechargeable devices may be known by using various cloud-based location services and/or cellular location management. These services may track the location of the IoT devices 110a-n and report when a device moves to a new location (a change in location) to the power harvesting orchestrator 150.

The power harvesting orchestrator 150 may further be configured to detect the network devices 120a-m of at least two communication networks e.g., a wireless local access network (Wi-Fi), a cellular network (5G or 6G network), and/or an enterprise network (private 5G network). The power harvesting orchestrator 150 may multicast a discovery probe to the network devices 120a-m and obtain, from each network device, a response including device attributes, a location, and an identification of one or more connected IoT devices to a respective network device. Device attributes may include energy harvesting capabilities of the network device i.e., power sourcing capability.

Based on detected ones of the network devices 120a-m and energy related parameters of the IoT devices 110a-n, and the policies 142a-j, the power harvesting orchestrator 150 orchestrates recharging of IoT devices 110a-n in a coordinated manner. The IoT devices 110a-n may harvest energy from millimeter wave (mmWave), Wi-Fi wireless networks, and 5G/6G cellular networks. The power harvesting orchestrator 150 coordinates power harvesting across these diverse domains based on the power harvesting schedule 152.

In one example embodiment, the power harvesting orchestrator 150 may generate the power harvesting schedule 152 based on predictive energy harvesting patterns of the IoT devices 110a-n. For example, machine learning may be performed based on historical power harvesting data (e.g., a time interval with a beam direction and a location for each IoT device). Devices may then be grouped into a charging group based on their predictive energy harvesting patterns.

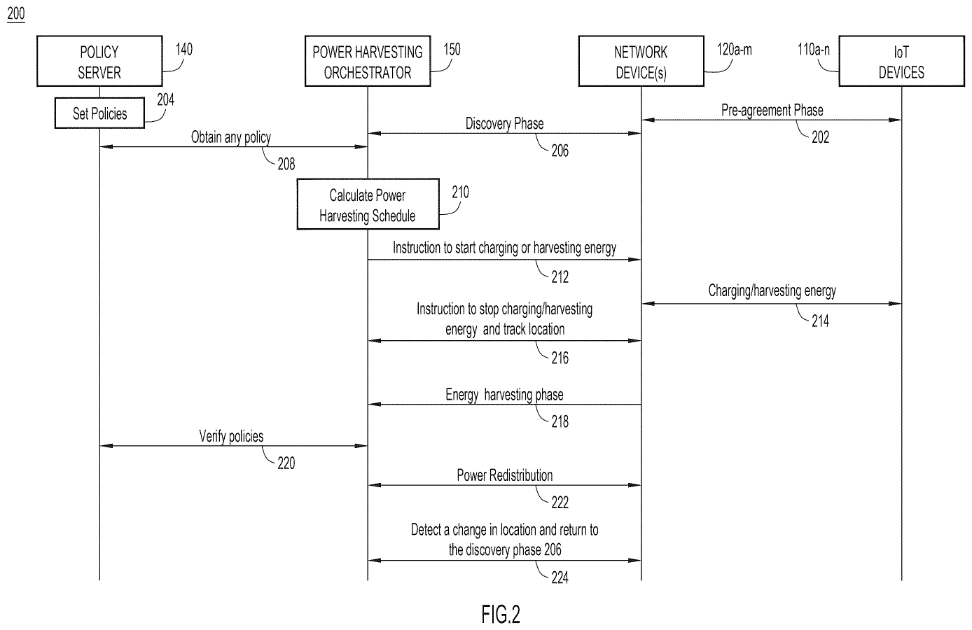

The power harvesting orchestrator 150 identifies rechargeable devices that are connected and facilitates energy harvesting, an example of which is detailed in FIG. 2. The power harvesting orchestrator 150 coordinates charging operations for the IoT devices 110a-n based on energy related parameters of the IoT devices 110a-n, which may be obtained from a datastore (database). These energy related parameters may include battery (capacitor) levels, charging efficiency curves (charging curve related data), location coordinates, mobility patterns, beamforming characteristics, and harvesting antenna parameters. The power harvesting orchestrator 150 executes algorithms leveraging energy related parameters in the datastore to compute the power harvesting schedule 152 in order to coordinate active charging and energy harvesting. The power harvesting schedule 152 may prioritize harvesting energy from the IoT devices 110a-n.

Time window(s) or time intervals are conveyed to selected network devices in the form of instructions, for example. In one example embodiment, the power harvesting schedule 152 includes charging window(s) for each respective IoT device and energy beamforming parameters including allocated beamforming resources. The power harvesting schedule 152 is generated based on the policies 142a-j that may define predetermined thresholds, optimization algorithms, and other rules for generating the power harvesting schedule 152.

With continued reference to FIG. 1, FIG. 2 is a sequence diagram illustrating a method 200 of performing wireless charging of IoT devices and harvesting energy from IoT devices based on the generated power harvesting schedule, according to an example embodiment. The method 200 involves the policy server 140, the power harvesting orchestrator 150, the network devices 120a-m, and IoT devices 110a-n, of FIG. 1.

The operations of the method 200 are analogous irrespective of a particular network device (i.e., a gateway) and irrespective of a connection method i.e., the communication network. In other words, the operations are the same for each network device whether the network device is a gateway of the enterprise network e.g., the ISR 120c, the access point 120a of the Wi-Fi network, or the base station 120m of a cellular network. In one or more example embodiments, the power harvesting orchestrator 150 is configured to communicate with the network devices 120a-m across domains using different communication protocols.

Specifically, the method 200 includes a pre-agreement phase 202. In the pre-agreement phase 202, the IoT devices 110a-n attach to respective network(s) via the network devices 120a-m. By way of an example, an IoT device may attach to a Wi-Fi network using a first network device (an access point), to a cellular network using a second network device (a base station/gNodeB (gNB), and to a private 5G network using a third network device (e.g., a service router). These three network devices may then provide information about attached IoT devices such as energy related parameters, location, an identification, etc., to a controller that manages its respective network. The controller of the respective network may communicate the energy related information about the IoT devices and the network devices of its network to the power harvesting orchestrator 150, in a discovery phase (detailed below).

Additionally, at the pre-agreement phase 202, each IoT device indicates an agreement to the respective network such, as “when I am at 30% battery, start to charge me, otherwise ask me”. Each IoT device communicates its energy related parameters and preferred charging and energy harvesting settings to the network (i.e., the network controller or the gateway device). The energy related parameters may further include an indication of whether a power sourcing mode and/or a power consuming mode are enabled.

In one example embodiment, some of the IoT devices 110a-n may function in both power consuming mode and power sourcing mode. For example, an IoT device equipped with a small solar panel may charge itself. Once fully charged (or charged to a certain level, which can be controlled by the policy server 140), the IoT device may continue acting in the power sourcing mode and transfer excess energy back to the power sources 130a-k of FIG. 1 (not shown) via the network devices using mmWave technology. As such, wireless devices (e.g., Wi-Fi, ISR, 5G node) are equipped to both send and receive power (bi-directional transfer of power). During the pre-agreement phase, the device's capability to operate in both modes (power consuming mode and power sourcing mode) is negotiated, ensuring that the power harvesting orchestrator 150 is aware of additional energy sources and performs charging that reduces interference with harvesting energy.

The method 200 further involves at 204, setting the policies 142a-j of FIG. 1 and storing them at the policy server 140. In one example embodiment, the power harvesting orchestrator 150 is tightly coupled with the policy server 140 that stores policies related to which device(s) are configured to generate power, when the power can be generated, and for how long and when respective device should be charged, duration for charging, etc. For example, a policy may be set that specifies “charge the first IoT device 110a of FIG. 1 only from power harvested sources when available; the first IoT device 110a has an identifier xxxx, and the power consuming mode and the power sourcing mode enabled on Mondays through Fridays, 8:00 am to 6 pm”. The policies involve which device, when, and for how long the device can consume the power. In other words, various policies may be set e.g., by enterprise(s) and/or users, and involve charging and/or energy harvesting preferences. The energy related parameters are analyzed based on the policies set at 204, to generate a power harvesting schedule that charges the IoT devices 110a-n and reduces interference with harvesting the energy from these IoT devices 110a-n.

The pre-agreement phase 202 and operation 204 of setting policies may be performed at various times in the method 200. That is, policies may be updated and IoT devices may change energy related parameters, move to different locations, renegotiate their agreements with the networks, etc.

The method 200 further involves performing a discovery phase 206. In the discovery phase 206, a discovery probe is multicast from the power harvesting orchestrator 150 to participating devices such as the network devices 120a-m. In one example embodiment, the network devices 120a-m may be controllers (e.g., a digital network architecture controller (DNAC), a wireless local access network controller (WLC), a 5G control center, etc.) and/or individual gateways (i.e., the ISR with dual connectivity for backup if not under controller domain).

When devices are charged via PoE, information is embedded in a link layer discovery protocol (LLDP) PoE extension via a custom type-length-value (TLV) to perform power harvest signaling. When the devices are powered by FMP, an analogous process may occur. In other words, there are various techniques for multicasting a discovery probe and the embodiments presented herein are not limited to LLDP or any particular protocol e.g., E2 Application Protocol (E2AP).

Additionally, during the discovery phase 206, capabilities and attributes of the network devices 120a-m are negotiated and stored at the power harvesting orchestrator 150. For example, the network devices 120a-m (Wi-Fi AP, ISR, 5G gNodeB) may be equipped to both send and receive power. Additionally, the network devices 120a-m may be configured to harvest energy e.g., include a solar panel to harvest solar energy. During this discovery phase 206, the capability of a device to operate as both power consuming mode and power sourcing mode is negotiated and stored.

The power harvesting orchestrator 150 gathers wireless network device information. For example, each network device returns to the power harvesting orchestrator 150 information about capabilities of its network devices and locations of the IoT devices under its control. The power harvesting orchestrator 150 obtains, from each network device, a response (to the multicast probe) including network device attributes, a location, and an identification for each connected or attached IoT device.

The method 200 further involves at 208, obtaining any policy from the policy server 140. Specifically, the power harvesting orchestrator 150 obtains rules from the policy server 140 (e.g., an enterprise policy server and/or a user subscriber service that stores user preferences). In one example, the power harvesting orchestrator 150 and the policy may be co-located or distributed software functions. The policy relates to charging the IoT devices 110a-n and/or harvesting energy from the IoT devices 110a-n. In one example embodiment, the policy prioritizes energy harvesting such that charging is performed at time intervals that do not interfere or reduce interfering with harvesting energy. The policy may include a charging duration (time window or time interval), an energy harvesting duration, a charging time, an energy harvesting time, and parameters for one or more network devices among the plurality of network devices for charging and/or harvesting the energy such as a beam direction.

At 210, the power harvesting orchestrator 150 generates the power harvesting schedule based on the policy obtained at 208 and network related parameters obtained in the discovery phase 206 (in response to the multicast discovery probe). For example, the power harvesting orchestrator 150 performs calculations of when it is optimal to charge IoT devices in a coverage area and which network(s)/network devices to use.

In computing optimal charging, the power harvesting orchestrator 150 considers various network related parameters obtained in the discovery phase 206. For example, network related parameters may include availability of power to harvest such as if there is an access point in the area that emits waves that an IoT device can use to harvest energy or for charging and/or whether sunlight is present for a device that has a solar panel attached to it. Network related parameters may include the number of devices to be charged e.g., one IoT device versus ten IoT devices in the proximity of the access point. The power harvesting orchestrator 150 tries to minimize the number of devices being charge per power emitter. That is, a lower number of charging devices on each emitter (e.g., one access point) is preferred.

Additionally, the network related parameters may involve current power level of each IoT device (current charge state) and a prediction of how fast the IoT device runs out of battery i.e., discharged. The power harvesting orchestrator 150 estimates remaining operational time based on the current charge state or level e.g., whether the IoT device can wait a predetermined time period prior to starting to charge (x minutes/y hours).

The network related parameters may further include predicted IOT device behavior e.g., historically the device has been moving every evening at 8PM and/or any policies that enforce specific behavior. For example, only charge a device type A when it is serviced by an access point A. The power harvesting orchestrator 150 generates the power harvesting schedule that aims to service as many IoT devices as possible and aims to harvest the largest amount of energy (include energy from the network devices when possible) based on analyzing various network related parameters.

In one example embodiment, if there is an ISR device on-site with dual connectivity to an enterprise network and via a cellular network for backup, and that charging capability is available via both channels, the power harvesting orchestrator 150 considers off-peak/non-working hours and in that way tracks the “charging capacity” across the domains. In other words, the power harvesting orchestrator 150 performs calculations to determine when it is optimal to harvest energy and when it is optimal to charge and which IoT devices.

Additionally, the power harvesting orchestrator 150 may group IoT devices for charging and/or energy harvesting based on energy related parameters, and control network device(s) to perform energy harvesting and/or charging. The power harvesting orchestrator 150 generates the power harvesting schedule based on the policies from the policy server 140. Further, as new information becomes available e.g., a new location for an IoT device that moved, a change in the policy, etc., the power harvesting orchestrator 150 may recalculate the power harvesting schedule. The power harvesting schedule may consider sustainability factors by prioritizing harvesting energy from the IoT devices 110a-n when possible, based on the policy.

The method 200 further involves at 212, the power harvesting orchestrator 150 providing an “advertisement” (i.e., instructions) to one or more network devices. For example, the “advertisement” indicates that power is available for harvesting and the advertisement (instruction) is propagated to the network devices 120a-m. This may happen at the time or as an advance announcement taking into consideration time-shifting (i.e., tell the IoT device(s) that if they wait for two hours, they can charge, etc.).

The power harvesting orchestrator 150 generates and provides instructions to selected network device(s). Instructions may involve enabling an energy harvesting mode in the selected network device such that the selected network device receives the energy from a first IoT device (that provided an indication of the power sourcing mode) and instructing the selected network device to charge a second IoT device such that the selected network device transmits power to charge the second IoT device.

The network device (e.g., the gateway where the user is connected such as the ISR, the access point, and/or the next generation node (gNB)) sees the advertisement and at 214, informs the IoT devices that the charging can start. As an example, this may be performed by enhancing the PoE extension to LLDP for the PSE/PD to communicate information via LLDP packets. At 214, the IoT devices 110a-n are charged and/or energy is harvested from the IoT devices 110a-n. For example, a first IoT device may return power/energy via port 10 of an access point and then based on another instruction from the power harvesting orchestrator 150, the access point charges a second IoT device via port 11.

If there is an influx of energy from renewable sources such as solar panels during a particular time of day, the power harvesting orchestrator 150 may be configured to prioritize power harvesting in these time intervals over periods reliant on fossil fuels. Without the power harvesting orchestrator 150, this information might not reach access points or 5G antennas, and as a result, such efficient scheduling would not occur (energy would be lost and not harvested).

At 216, the charging or energy harvesting is stopped and other charging may occur. For example, when the charging is complete (i.e., no longer optimal/full, etc.), the charging process of 214 stops and the controller may instruct other devices to charge. The power harvesting orchestrator 150 facilitates or controls the power harvesting stop and monitors location changes.

At 218, an energy harvesting phase may be performed. When a dual-mode capable IoT device (indicated as enabled to function as both power sourcing and power consuming) sends excess energy, it notifies the power harvesting orchestrator 150. The power harvesting orchestrator 150 coordinates with relevant network devices e.g., controllers or individual gateways, to activate a receiving mode.

At 220, the power harvesting orchestrator 150 may verify policies at the policy server 140 (as they relate to energy harvesting, for example) and at 222, the power harvesting orchestrator 150 performs power redistribution in which energy is sent back to a central network device and is redistributed as needed to other ports. For example, bi-directional PoE power may be sent back to central devices, coordinated and redistributed by the power harvesting orchestrator 150. As another example, the energy harvested from a respective IoT device by an access point may be provided to other IoT devices or back to the power sources 130a-k.

The method 200 further involves at 224, the power harvesting orchestrator 150 tracking location of IoT devices 110a-n. When an IoT device moves to a new location, location services are invoked and the power harvesting orchestrator 150 recalculates if more energy is available to be harvested at the new location. In particular, the method 200 is re-executed from the discovery phase at 206 (i.e., gathering or obtaining energy related parameters). As an example, location services may be used for location tracking i.e., tracking movement of IoT devices. As soon as the rechargeable device is connected (at a new location), it triggers the power harvesting orchestrator 150 to start advertising harvesting capabilities.

While in one example embodiment, signaling described in Institute of Electrical and Electronics Engineers (IEEE) 802.3 for PoE, modified to support new TLV values for over-the-air power harvesting, may be used, custom implementations of embedded signaling to facilitate over-the-air power harvesting may also be used e.g., for FMP. This is provided by way of an example only. Other signaling is within the scope of this disclosure.

With continued reference to FIGS. 1 and 2, FIG. 3 is a diagram illustrating an environment 300 in which multiple network devices of different communication networks charge a set of IoT devices, according to an example embodiment.

The environment 300 includes a plurality of devices 332a-g such as a first thermostat 332a, a second thermostat 332b, a third thermostat 332c, a fourth thermostat 332d, a fifth thermostat 332e, a sixth thermostat 332f, and a seventh thermostat 332g. The thermostats are just examples of IoT devices. The environment 300 further includes the access point 120a that forms a first mmWave beam 320a, the ISR 120c that forms a second mmWave beam 320b, and the base station 120m that forms a third mmWave beam 320c, of FIG. 1. The environment 300 also includes a controller 310 that may execute the power harvesting orchestrator 150 (optionally with the policy server 140) of FIG. 1 and may include an AI/ML module 312. In one example embodiment, the AI/ML module 312 may be executed separately on one or more computing devices and may communicate with the controller 310 via a network.

Based on the generated power harvesting schedule, the controller 310 may group a set of IoT devices 332a-e together using machine learning. These devices may be grouped together based on a time, a duration (time window or time interval), and their current location. For example, this set of IoT devices 332a-e is in the same coverage area 330 i.e., located close to one another or within a predetermined spatial distance. Based on energy related parameters, the power harvesting schedule may indicate that this set of IoT devices 332a-e is to be charged at approximately the same time and may or may not share the same charging duration. Based on similarities in power charging attributes, the controller 310 groups the IoT devices 332a-e together for charging. Similarly, the controller 310 may group another set of IoT devices for energy harvesting.

Additionally, the controller 310 selects one or more of the network devices 120a-m for charging this set of IoT devices 332a-e i.e., the access point 120a, the ISR 120c, and the base station 120m (network devices that are associated with different communication networks). The selection may be based on policies that may prioritize network devices with smaller workloads, efficient charging capabilities, etc. The controller 310 then generates and provides instructions to the selected network devices.

In particular, the controller 310 instructs the access point 120a to set its beam direction to coordinates x1, y1 to form the first mmWave beam 320a, instructs the ISR 120c to set its beam direction to the same coordinates to form the second mmWave beam 320b, and the base station 120m to set its beam direction to these same coordinates to form the third mmWave beam 320c. As such, these network devices set their beam direction to the coverage area 330 (shown as overlapping beams 320a-c) in which the set of IoT devices 332a-e are located. The controller 310 instructs these network devices to transmit power for charging this set of IoT devices 332a-e during at least one time window (same time interval).

The controller 310 directs the base station 120m to transmit focused energy beams (third mmWave beam 320c) over dedicated airtime resources towards a device antenna to enable targeted wireless charging. Equipped with a small motor and an mmWave antenna used for a cellular network, the base station 120m adjusts its direction to optimize connectivity and charging for the set of IoT devices 332a-e in the coverage area 330. The base station 120m focuses its energy beams onto the coverage area 330, as instructed by the controller 310.

Similarly, the access point 120a and the ISR 120c are equipped with small motors and mmWave antennas used for Wi-Fi and enterprise network, respectively. The access point 120a and the ISR 120c adjust their antenna directions to optimize connectivity and charging for the set of IoT devices 332a-e in the same coverage area 330. As such, the energy beams (the first mmWave beam 320a and the second mmWave beam 320b) overlap and together charge the set of IoT devices 332a-e. Since the seventh thermostat 332g and the sixth thermostat 332f are outside the coverage area 330, they are not charged together with the thermostats 332a-e. Also, some of these IoT devices in the coverage area 330 maybe charged with one or two overlapping beams from the respective network devices (and not all three network devices) e.g., the fifth thermostat 332e.

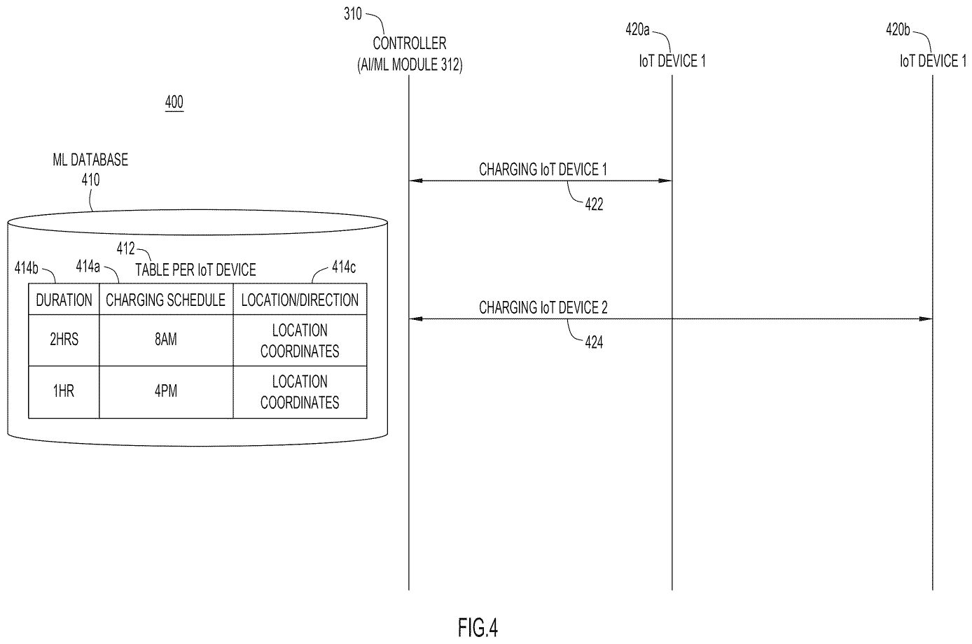

The controller 310 obtains network related parameters (data about current operating state and current energy/power state of network devices and/or IoT devices) to allow the AI/ML module 312 to generate predictive energy patterns per each device for use in generating the power harvesting schedule, an example is described in FIG. 4.

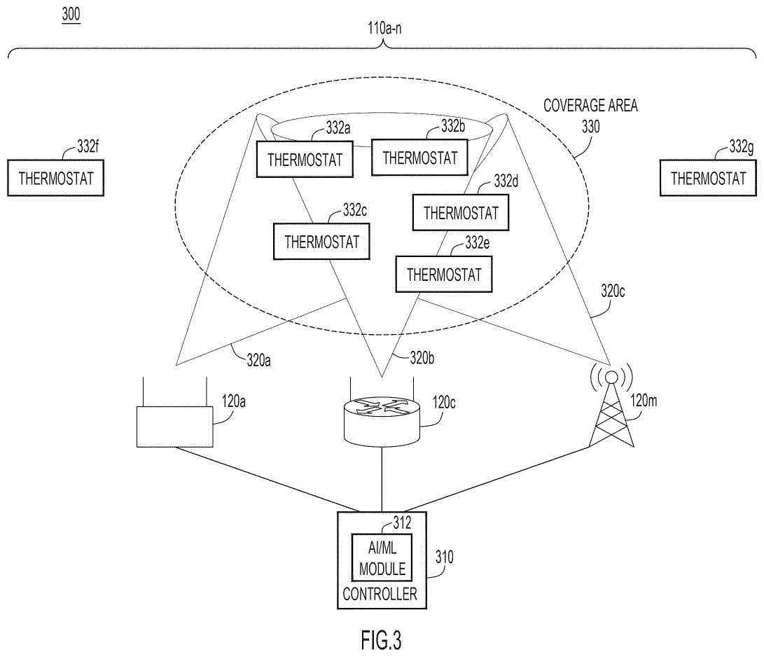

With continued reference to FIGS. 1-3, FIG. 4 is a sequence diagram illustrating a charging method 400 of performing wireless charging of IoT devices based on predictive energy harvesting patterns of the IoT devices, according to an example embodiment. The charging method 400 involves the controller 310 of FIG. 3 that obtains energy related parameters from a machine learning (ML) database 410 and charges a first IoT device 420a and a second IoT device 420b. Based on charging performed thus far and other information from the IoT devices, the AI/ML module 312 generates a predictive energy harvesting pattern for each device and stores and/or updates a table 412 with the predictive energy harvesting pattern for the respective device in the ML database 410.

One of the integral functions of the controller 310 is utilizing artificial intelligence (AI) and/or machine learning (ML) to prevent loss of energy that may be harvested otherwise. As noted above, network devices are equipped with small motors and mmWave antennas used for a respective communication network (Wi-Fi, enterprise network, or cellular network) and can adjust their direction to optimize connectivity and charging for the first IoT device 420a and the second IoT device 420b. The controller 310 includes the AI/ML module 312 that learns charging patterns over time and preferred directions of the first IoT device 420a and the second IoT device 420b.

Specifically, the AI/ML module 312 obtains data about harvesting energy from the first IoT device 420a and the second IoT device 420b. The AI/ML module 312 generates a predictive energy harvesting pattern for each IoT device. In one or more example embodiments, the AI/ML module 312 may perform a combination of reinforcement learning (RL) and clustering techniques.

For example, reinforcement learning (RL) may be preferred when the controller 310 is to learn an optimal policy through trial and error interactions with the environment that includes the network devices and IoT devices. The goal may be to maximize a cumulative reward such as the number of IoT devices successfully charged. The reinforcement learning may output information about beam directions i.e., the controller 310 may direct mmWave beams to the environment (a network of IoT devices requesting charging) based on the output information. The reinforcement learning uses state information including current configuration of IoT devices, their locations, and their charging needs to learn the environment and maximize the cumulative reward. The reinforcement learning involve actions of setting the direction and scheduling of the mmWave beams and reward of the number of IoT devices successfully charged within a given time frame. Using a feedback loop, the AI/ML module 312 learns to increase (or maximize) the reward (devices charged).

In one or more example embodiments, clustering algorithms may be used to group IoT devices based on their charging schedules and locations. This helps in predicting optimal beam directions at different times of the day. A clustering algorithm may involve data collection, feature extraction, clustering, and predictions. In data collection, data is obtained including charging requests having a duration, a schedule, and a location. In feature extraction, features such as time of day, location coordinates, and charging duration are extracted. In clustering, various techniques such as K-Means or Density-Based Spatial Clustering of Applications with Noise (DBSCAN) are applied to a group of IoT devices with similar charging patterns. The clustering technique outputs prediction(s) such as optimal beam directions for different times of the day.

A feedback loop fine tunes the AI/ML model and may involve initial training, feedback data gathering, and an iterative process, based on performance metrics.

In the initial training, initial data is obtained and may include charging requests (duration, schedule, and location). Feature engineering may then be performed based on the initial data. Feature engineering may involve extracting features such as the time of day, the location coordinates, and the charging durations. Clustering technique(s) are then applied to a group of IoT devices with similar charging patterns. Reinforcement learning is then performed in which the clustered data is used to train the RL model to adjust beam directions and schedules.

In the feedback data gathering or feedback collection, a beam direction execution involves, at certain intervals, the controller 310 directs the mmWave beams to charge a group of IoT devices. The charging status (current charge state) is then recorded for each IoT device in the beam's direction. The controller 310 compares the expected charge status (starving mode) with the actual charge status. The controller 310 may then identify devices that have sufficient charge and devices that are still in need of charging.

In the feedback loop data update (iterative process), the controller 310 updates dataset(s) with new charge status information. The controller 310 then performs re-clustering in which one or more clustering techniques incorporate the new data and potentially form new or adjusted clusters. The RL model is fine-tuned based on the updated clusters. The RL model thus learns to improve predictions about which devices are to be charged and adjusts the beam directions accordingly. The controller 310 performs this iterative process continuously based on the feedback (i.e., continuous repeat of the feedback loop to keep refining the model). Each iteration may improve the accuracy of the beam direction and scheduling. The controller 310 tracks performance metrics such as the number of devices successfully charged, the efficiency of the beam direction, and the reduction in overcharging devices and updates the energy harvesting schedule by applying an AI/ML model(s) to the performance metrics.

Similarly, the predictive energy harvesting pattern includes a time interval or a time window with a beam direction and/or a location. Over time, the AI/ML module 312 within the controller 310 learns charging patterns and preferred directions of IoT devices, enabling the AI/ML module 312 to predict and efficiently direct energy to where it is needed most. The AI/ML module 312 may track attributes such as charging curve related data, location coordinates, mobility patterns (location changes/device movements), energy beamforming characteristics, and/or harvesting antenna parameters and computing predictive energy harvesting patterns. The predictive energy harvesting patterns are stored in the ML database 410 and are updated as IoT devices charge.

The AI/ML module 312 maintains a table 412 for each IoT device. The table 412 includes a learned charging schedule 414a, a duration 414b of the charging, and a location/direction 414c of the respective IoT device. The AI/ML module 312 performs machine learning based on the table 412 for each IoT device to group these devices into sets for charging and/or harvesting energy. The devices may be grouped based on the learned charging schedule 414a of each device and location/direction 414c (beam direction). For example, a first set of IoT devices located in a certain area/beam direction and that usually charge between 8 am and 10 am may be grouped together. The controller 310 analyzes information in tables for IoT devices to group devices together for charging and/or energy harvesting.

The controller 310 coordinates with cellular, Wi-Fi, and ISR systems and shares beam direction and duration. Consequently, mmWave devices generate a coordinated beam in a specific direction e.g., between 8 am and 10 am, ensuring that a maximum number of devices in a group are charged. The controller 310 may categorize IoT devices based on their charging requests and direct mmWave beams of network devices to maximize charging efficiency and minimize energy loss. By grouping IoT devices and enabling charging to multiple IoT devices at a time (common time and within the same range) the charging is performed simultaneously. Additionally, power returned back by PoE patterns may be used for predicted future use and provide more sustainable power supply to the IoT devices.

The charging method 400 involves at 422, charging the first IoT device 420a based on the table 412 for the first IoT device 420a and at 424, charging the second IoT device 420b based on the table 412 for the second IoT device 420b.

The techniques presented herein provide an enterprise network-wide power harvesting orchestrator configured to efficiently manage charging/recharging of IoT devices across an enterprise network, leveraging energy from sources like mmWave, Wi-Fi, and 5G/6G. The power harvesting orchestrator uses a coordinated approach to optimize the charging process by considering device locations, energy source(s) and availability, and optimal charging times. The power harvesting orchestrator allows for cross domain power distribution and/or energy harvesting using diverse control plane type signaling. The power harvesting orchestrator may involve AI/ML to generate predictive energy harvesting patterns for IoT devices and generate power harvesting schedules based on these predictive energy harvesting patterns. The power harvesting orchestrator fills a technological gap previously unaddressed by providing network-wide, cross domain, coordinated power harvesting capabilities.

While the method involves two IoT devices, the disclosure provides for coordinated charging of multiple ambient IoT devices based on tracking energy related parameters. The power harvesting orchestrator dynamically manages wireless charging of IoT devices connected to several communication networks.

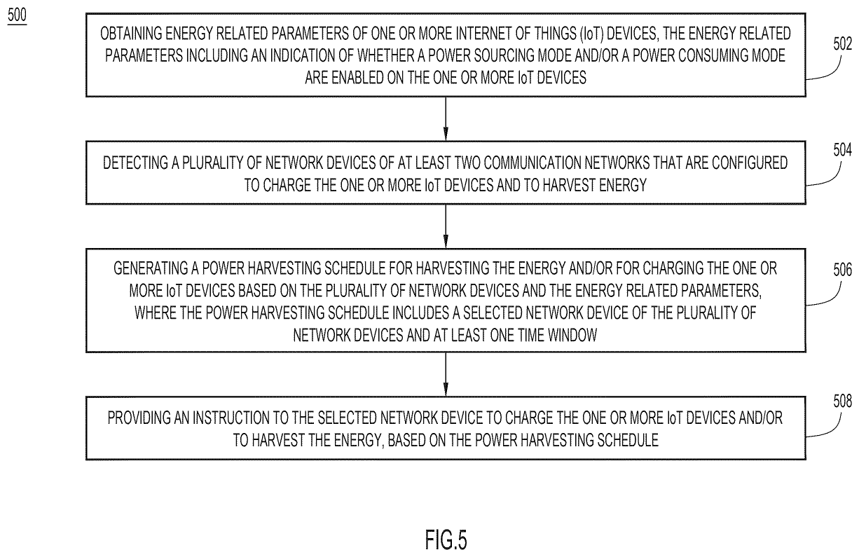

FIG. 5 is a flowchart illustrating a computer-implemented method 500 of generating a power harvesting schedule and providing instructions for charging one or more IoT devices and/or harvesting energy from the one or more IoT devices based on the power harvesting schedule, according to an example embodiment. The computer-implemented method 500 may be performed by one or more computing devices or an apparatus. For example, the computer-implemented method 500 may be performed by the power harvesting orchestrator 150 of FIG. 1 or FIG. 2 and/or executed by a controller e.g., the controller 310 of FIG. 3 or FIG. 4.

The computer-implemented method 500 involves at 502, obtaining energy related parameters of one or more Internet of Things (IoT) devices. The energy related parameters include an indication of whether a power sourcing mode and/or a power consuming mode are enabled on the one or more IoT devices.

The computer-implemented method 500 further involves at 504, detecting a plurality of network devices of at least two communication networks that are configured to charge the one or more IoT devices and to harvest energy.

The computer-implemented method 500 further involves at 506, generating a power harvesting schedule for harvesting the energy and/or for charging the one or more IoT devices based on the plurality of network devices and the energy related parameters. The power harvesting schedule includes a selected network device of the plurality of network devices and at least one time window.

The computer-implemented method 500 further involves at 508, providing an instruction to the selected network device to charge the one or more IoT devices and/or to harvest the energy, based on the power harvesting schedule.

According to one or more example embodiments, the at least two communication networks may include a wireless local access network, a cellular network, and/or an enterprise network. The plurality of network devices may include one or more instances of an access point, a network controller, a base station, and/or a gateway device.

In one instance, the operation 504 of detecting the plurality of network devices of the at least two communication networks may include multicasting a discovery probe to the plurality of network devices and obtaining, from each of the plurality of network devices, a response including device attributes, a location, and an identification of one or more connected IoT devices to a respective network device.

According to one or more example embodiments, the computer-implemented method 500 may further include obtaining a policy for charging the one or more IoT devices and harvesting the energy from the one or more IoT devices and the plurality of network devices. The policy may include a charging duration, an energy harvesting duration, a charging time, an energy harvesting time, and parameters for one or more network devices among the plurality of network devices for charging and/or harvesting the energy. Additionally, the power harvesting schedule is further generated in operation 506 based on the policy.

In one form, the operation 508 of providing the instruction to the selected network device may involve enabling an energy harvesting mode in the selected network device such that the selected network device receives the energy from a first IoT device of the one or more IoT devices. The operation 508 of providing the instruction to the selected network device may further involve instructing the selected network device to charge a second IoT device of the one or more IoT devices such that the selected network device transmits power to charge the second IoT device.

In another form, the computer-implemented method 500 may further include detecting that a first IoT device of the one or more IoT devices has moved to a new location and generating a new power harvesting schedule based on an availability of the plurality of network devices at the new location and the energy related parameters of the first IoT device.

In yet another form, the operation 506 of generating the power harvesting schedule may include obtaining harvesting data about harvesting the energy from the one or more IoT devices and performing machine learning based on the harvesting data to generate a predictive energy harvesting pattern for each of the one or more IoT devices. The predictive energy harvesting pattern may include a time interval with a beam direction and a location. The operation 506 of generating the power harvesting schedule may include generating the power harvesting schedule based on the predictive energy harvesting pattern for each of the one or more IoT devices.

According to one or more example embodiments, the one or more IoT devices may include a plurality of IoT devices. The operation 506 of generating the power harvesting schedule may include grouping a set of IoT devices using machine learning based on a time, a duration, and a location for charging and generating the power harvesting schedule for charging the set of IoT devices together by the selected network device.

In one instance, the selected network device may include a first network device of a first communication network and a second network device of a second communication network different than the first communication network. The operation 508 of providing the instruction to the selected network device may include setting a first beam direction for the first network device and a second beam direction for the second network device and controlling the first network device and the second network device to transmit power for charging the set of IoT devices during the at least one time window.

In another instance, the operation 506 of generating the power harvesting schedule is based on a first location of each of the one or more IoT devices and a second location of each of the plurality of network devices. The computer-implemented method 500 may further include generating the power harvesting schedule that prioritizes the energy from the one or more IoT devices and such that charging of the one or more IoT devices may be performed to reduce interference with harvesting the energy.

FIG. 6 is a hardware block diagram of a computing device 600 that may perform functions associated with any combination of operations in connection with the techniques depicted in FIGS. 1-5, according to various example embodiments, including, but not limited to, operations of one or more entities of FIGS. 1 and 2 such as one of the IoT devices 110a-n, one of the network devices 120a-m, the policy server 140, the power harvesting orchestrator 150, and/or the operations of the one or more entities of FIGS. 3 and 4 such as the controller 310. It should be appreciated that FIG. 6 provides only an illustration of one example embodiment and does not imply any limitations with regard to the environments in which different example embodiments may be implemented. Many modifications to the depicted environment may be made.

In at least one embodiment, computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with one or more memory elements 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, and/or any other I/O port(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 616, a display screen (touch screen on a mobile device), or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory and a network interface configured to enable network communications. The apparatus further includes a processor. In this apparatus, the processor is configured to perform a method, which includes obtaining energy related parameters of one or more Internet of Things (IoT) devices. The energy related parameters include an indication of whether a power sourcing mode and/or a power consuming mode are enabled on the one or more IoT devices. The method further includes detecting a plurality of network devices of at least two communication networks that are configured to charge the one or more IoT devices and to harvest energy and generating a power harvesting schedule for harvesting the energy and/or for charging the one or more IoT devices based on the plurality of network devices and the energy related parameters. The power harvesting schedule includes a selected network device of the plurality of network devices and at least one time window. The method further involves providing an instruction to the selected network device to charge the one or more IoT devices and/or to harvest the energy, based on the power harvesting schedule.

In yet another example embodiment, one or more non-transitory computer readable storage media encoded with instructions are provided. When the media is executed by a processor, the instructions cause the processor to execute a method that involves obtaining energy related parameters of one or more Internet of Things (IoT) devices. The energy related parameters include an indication of whether a power sourcing mode and/or a power consuming mode are enabled on the one or more IoT devices. The method further involves detecting a plurality of network devices of at least two communication networks that are configured to charge the one or more IoT devices and to harvest energy and generating a power harvesting schedule for harvesting the energy and/or for charging the one or more IoT devices based on the plurality of network devices and the energy related parameters. The power harvesting schedule includes a selected network device of the plurality of network devices and at least one time window. The method further involves providing an instruction to the selected network device to charge the one or more IoT devices and/or to harvest the energy, based on the power harvesting schedule.

In yet another example embodiment, a system is provided that includes the devices and operations explained above with reference to FIGS. 1-6.

The programs described herein (e.g., control logic 620) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 606 and/or memory elements(s) 604 can store data, software, code, instructions (e.g., processor instructions), logic, parameters, combinations thereof, and/or the like used for operations described herein. This includes the storage 606 and/or memory elements(s) 604 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., WiFi®/WiFi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining energy related parameters of one or more Internet of Things (IoT) devices, the energy related parameters including an indication of whether a power sourcing mode and/or a power consuming mode are enabled on the one or more IoT devices;
detecting a plurality of network devices of at least two communication networks that are configured to charge the one or more IoT devices and to harvest energy;
generating a power harvesting schedule for harvesting the energy and/or for charging the one or more IoT devices based on the plurality of network devices and the energy related parameters, wherein the power harvesting schedule includes a selected network device of the plurality of network devices and at least one time window; and
providing an instruction to the selected network device to charge the one or more IoT devices and/or to harvest the energy, based on the power harvesting schedule.

2. The computer-implemented method of claim 1, wherein the at least two communication networks include a wireless local access network, a cellular network, and/or an enterprise network, and wherein the plurality of network devices include one or more instances of an access point, a network controller, a base station, and/or a gateway device.

3. The computer-implemented method of claim 2, wherein detecting the plurality of network devices of the at least two communication networks includes:
multicasting, by a power harvesting orchestrator, a discovery probe to the plurality of network devices; and
obtaining, by the power harvesting orchestrator from each of the plurality of network devices, a response including device attributes, a location, and an identification of one or more connected IoT devices to a respective network device.

4. The computer-implemented method of claim 1, further comprising:
obtaining a policy for charging the one or more IoT devices and harvesting the energy from the one or more IoT devices and the plurality of network devices, wherein the policy includes a charging duration, an energy harvesting duration, a charging time, an energy harvesting time, and parameters for one or more network devices among the plurality of network devices for charging and/or harvesting the energy,
wherein the power harvesting schedule is further generated based on the policy.

5. The computer-implemented method of claim 1, wherein providing the instruction to the selected network device includes:
enabling, by a power harvesting orchestrator, an energy harvesting mode in the selected network device such that the selected network device receives the energy from a first IoT device of the one or more IoT devices; and
instructing, by the power harvesting orchestrator, the selected network device to charge a second IoT device of the one or more IoT devices such that the selected network device transmits power to charge the second IoT device.

6. The computer-implemented method of claim 1, further comprising:
detecting that a first IoT device of the one or more IoT devices has moved to a new location; and
generating a new power harvesting schedule based on an availability of the plurality of network devices at the new location and the energy related parameters of the first IoT device.

7. The computer-implemented method of claim 1, wherein generating the power harvesting schedule includes:
obtaining harvesting data about harvesting the energy from the one or more IoT devices;
performing machine learning based on the harvesting data to generate a predictive energy harvesting pattern for each of the one or more IoT devices, wherein the predictive energy harvesting pattern includes a time interval with a beam direction and a location; and
generating the power harvesting schedule based on the predictive energy harvesting pattern for each of the one or more IoT devices.

8. The computer-implemented method of claim 1, wherein the one or more IoT devices include a plurality of IoT devices and generating the power harvesting schedule includes:
grouping a set of IoT devices using machine learning based on a time, a duration, and a location for charging; and
generating the power harvesting schedule for charging the set of IoT devices together by the selected network device.

9. The computer-implemented method of claim 8, wherein the selected network device includes a first network device of a first communication network and a second network device of a second communication network different than the first communication network, and providing the instruction to the selected network device includes:
setting a first beam direction for the first network device and a second beam direction for the second network device; and
controlling the first network device and the second network device to transmit power for charging the set of IoT devices during the at least one time window.

10. The computer-implemented method of claim 1, wherein generating the power harvesting schedule is based on a first location of each of the one or more IoT devices and a second location of each of the plurality of network devices, and further comprising:
generating the power harvesting schedule that prioritizes the energy from the one or more IoT devices and such that charging of the one or more IoT devices is performed to reduce interference with harvesting the energy.

11. An apparatus comprising:
a memory;
a network interface configured to enable network communications; and
a processor, wherein the processor is configured to perform a method comprising:
obtaining energy related parameters of one or more Internet of Things (IoT) devices, the energy related parameters including an indication of whether a power sourcing mode and/or a power consuming mode are enabled on the one or more IoT devices;
detecting a plurality of network devices of at least two communication networks that are configured to charge the one or more IoT devices and to harvest energy;
generating a power harvesting schedule for harvesting the energy and/or for charging the one or more IoT devices based on the plurality of network devices and the energy related parameters, wherein the power harvesting schedule includes a selected network device of the plurality of network devices and at least one time window; and
providing an instruction to the selected network device to charge the one or more IoT devices and/or to harvest the energy, based on the power harvesting schedule.

12. The apparatus of claim 11, wherein the at least two communication networks include a wireless local access network, a cellular network, and/or an enterprise network, and wherein the plurality of network devices include one or more instances of an access point, a network controller, a base station, and/or a gateway device.

13. The apparatus of claim 12, wherein the apparatus is a power harvesting orchestrator and the processor is configured to detecting the plurality of network devices of the at least two communication networks by:
multicasting a discovery probe to the plurality of network devices; and
obtaining, from each of the plurality of network devices, a response including device attributes, a location, and an identification of one or more connected IoT devices to a respective network device.

14. The apparatus of claim 11, wherein the processor is further configured to perform:
obtaining a policy for charging the one or more IoT devices and harvesting the energy from the one or more IoT devices and the plurality of network devices, wherein the policy includes a charging duration, an energy harvesting duration, a charging time, an energy harvesting time, and parameters for one or more network devices among the plurality of network devices for charging and/or harvesting the energy,
wherein the power harvesting schedule is further generated based on the policy.

15. The apparatus of claim 11, wherein the apparatus is a power harvesting orchestrator and the processor is configured to provide the instruction to the selected network device by:
enabling an energy harvesting mode in the selected network device such that the selected network device receives the energy from a first IoT device of the one or more IoT devices; and
instructing the selected network device to charge a second IoT device of the one or more IoT devices such that the selected network device transmits power to charge the second IoT device.

16. The apparatus of claim 11, wherein the processor is further configured to perform:
detecting that a first IoT device of the one or more IoT devices has moved to a new location; and
generating a new power harvesting schedule based on an availability of the plurality of network devices at the new location and the energy related parameters of the first IoT device.

17. The apparatus of claim 11, wherein the processor is configured to generate the power harvesting schedule by:
obtaining harvesting data about harvesting the energy from the one or more IoT devices;
performing machine learning based on the harvesting data to generate a predictive energy harvesting pattern for each of the one or more IoT devices, wherein the predictive energy harvesting pattern includes a time interval with a beam direction and a location; and
generating the power harvesting schedule based on the predictive energy harvesting pattern for each of the one or more IoT devices.

18. One or more non-transitory computer readable storage media encoded with software comprising computer executable instructions that, when executed by a processor, cause the processor to perform a method including:
obtaining energy related parameters of one or more Internet of Things (IoT) devices, the energy related parameters including an indication of whether a power sourcing mode and/or a power consuming mode are enabled on the one or more IoT devices;
detecting a plurality of network devices of at least two communication networks that are configured to charge the one or more IoT devices and to harvest energy;
generating a power harvesting schedule for harvesting the energy and/or for charging the one or more IoT devices based on the plurality of network devices and the energy related parameters, wherein the power harvesting schedule includes a selected network device of the plurality of network devices and at least one time window; and
providing an instruction to the selected network device to charge the one or more IoT devices and/or to harvest the energy, based on the power harvesting schedule.

19. The one or more non-transitory computer readable storage media according to claim 18, wherein the at least two communication networks include a wireless local access network, a cellular network, and/or an enterprise network, and wherein the plurality of network devices include one or more instances of an access point, a network controller, a base station, and/or a gateway device.

20. The one or more non-transitory computer readable storage media according to claim 18, wherein the computer executable instructions cause the processor to detect the plurality of network devices of the at least two communication networks by:
multicasting a discovery probe to the plurality of network devices; and
obtaining, from each of the plurality of network devices, a response including device attributes, a location, and an identification of one or more connected IoT devices to a respective network device.
